(19) United States
(12) Patent Application Publication
(10) Pub. No.: US 2009/0284538 A1
(43) Pub. Date: Nov. 19, 2009

(54) VIDEO STREAMING DATA PROCESSING METHOD

(75) Inventors: HUNG-YI LIN, Taipei (TW); CHI-YI TSAI, Taipei (TW)

Correspondence Address: WPAT, PC, 7225 BEVERLY ST., ANNANDALE, VA, 22003, US

(73) Assignee: ASUSTEK COMPUTER INC., Taipei (TW)

(21) Appl. No.: 12/437,351

(22) Filed: May 7, 2009

(30) Foreign Application Priority Data
May 16, 2008 (TW) 097118164

(51) Int. Cl. G06T 11/40

(52) U.S. Cl. 345/552

(57) ABSTRACT

A video streaming data processing method is used in a video streaming data processing system including a central processing unit, a system memory, a graphic processing unit and a video random-access memory. After video streaming data are received, a video decoding operation is performed on the video streaming data by the central processing unit to produce image data and the image data are then stored into the system memory. Next, the image data are stored from the system memory to a texture buffer of the video random-access memory. Next, the image data that are stored in the texture buffer are read out and subject to a specific image processing algorithm by the graphic processing unit, and then stored back to the texture buffer. Afterwards, the image data are stored from the texture buffer to a video buffer of the video random-access memory.

### FIELD OF THE INVENTION

The present invention relates to a video streaming data processing method, and more particularly to a video streaming data processing method for use in a video streaming data processing system.

### BACKGROUND OF THE INVENTION

Conventionally, a central processing unit (CPU) is used as a video processor of a computer system. FIG. 1A is a schematic functional block diagram illustrating a video streaming data processing system of a computer. As shown in FIG. 1A, the video streaming data processing system principally comprises three main parts, including a central processing unit (CPU) 10, a system memory 11 and a video graphic card 12. The video streaming data processing system is interconnected between a video streaming input component 18 and a video streaming output component 19. After the video streaming data generated by the video streaming input component 18 are received and processed by the video streaming data processing system, the processed video streaming data are transmitted to the video streaming output component 19 for display. An example of the video streaming input component 18 includes a hard disk 181 or a video camera 182. The hard disk 181 is used for storing the video streaming data. The video camera 182 may generate the video streaming data in real time. The video streaming output component 19 includes for example a monitor 191 or a projector 192.

Please refer to FIG. 1A again. The system memory 11 comprises a memory buffer 111 and image data 112. The video graphic card 12 comprises a video random-access memory (video RAM) 121 having a video buffer 1210, a graphic processing unit (GPU) 122, a frame buffer 123 and a random-access memory digital-to-analog converter (RAMDAC) 124.

Hereinafter, a conventional video streaming data processing method will be illustrated with reference to the flowchart of FIG. 1B and the video streaming data processing system of FIG. 1A.

First of all, along the transmission path S11, the video streaming data that are transmitted from the video streaming input component 18 are stored in the memory buffer 111 of the system memory 11 and then the central processing unit 10 performs a video decoding operation on the video streaming data (Step 101). Next, along the transmission path S12, the image data 112 obtained from the video decoding operation are stored to the system memory 11, read out and subject to a post-processing operation by the central processing unit 10, and the image data 112 are then stored back to the system memory 11 (Step 102). The image processing operation on the image data 112 includes some specific image processing algorithms such as color enhancement, saturation enhancement and the like. As known, the successive procedures of generating, storing, reading out, post-processing and storing back the image data along the transmission path S12 are time-consuming and thus the overall performance of the computer system is usually impaired.

Next, by the central processing unit 10, the image data 112 are stored from the system memory 11 to the video buffer 1210 of the video RAM 121 along the transmission path S13 (Step 103). The procedure of storing the image data 112 from the system memory 11 to the video graphic card 12 (i.e. the Step 103) is illustrated in more details with reference to FIG. 1C. In other words, by utilizing a software-form rendering filter 13 and through a DirectDraw library 14, the central processing unit 10 may store the image data 112 from the system memory 11 to the video buffer 1210 of the video RAM 121. Next, the image data 112 that are stored in the video buffer 1210 are moved to the frame buffer 123 of the video graphic card 12 by the graphic processing unit (GPU) 122 and ready to be transmitted to the video streaming output component 19 (Step 104). Next, the digital image data stored in the frame buffer 123 are converted into analog image data by the RAMDAC 124 so as to be transmitted to the video streaming output component 19 for display (Step 105).

Since the video decoding operation and the specific image processing algorithm of the image processing operation are performed by the central processing unit 10, the computing load of the central processing unit 10 is very heavy. If the processing capability of the central processing unit 10 is insufficient, the central processing unit 10 is usually unable to simultaneously perform the video decoding operation and the specific image processing algorithm. Under this circumstance, the overall performance of the computer system is impaired and even the video streaming data fail to be normally played.

### SUMMARY OF THE INVENTION

The present invention relates to a video streaming data processing method for use in a video streaming data processing system in order to reduce the computing load of the central processing unit and enhance the overall performance of the computer system.

In an embodiment, the present invention provides a video streaming data processing method for use in a video streaming data processing system including a central processing unit, a system memory, a graphic processing unit and a video random-access memory. After video streaming data are received, a video decoding operation is performed on the video streaming data by the central processing unit to produce image data and the image data are then stored into the system memory. Next, the image data are stored from the system memory to a texture buffer of the video random-access memory. Next, the image data that are stored in the texture buffer are read out and subject to a specific image processing algorithm by the graphic processing unit, and then stored back to the texture buffer. Afterwards, the image data are stored from the texture buffer to a video buffer of the video random-access memory.

In another embodiment, the present invention provides a video streaming data processing method for use in a video streaming data processing system including a central processing unit, a system memory, a graphic processing unit and a video random-access memory. After video streaming data are received, a video decoding operation is performed on the video streaming data by the central processing unit to produce image data and the image data are then stored into the system memory. Next, the image data are stored from the system memory to a texture buffer of the video random-access memory. Next, the image data that are stored in the texture buffer are read out are subject to a specific image processing algorithm by the graphic processing unit, and then stored back to the texture buffer. Next, the image data are stored from the texture buffer to the system memory. The image data stored in the system memory are read out and subject to a post-processing operation by the central processing unit, and then stored back to the system memory. Afterwards, the image data are stored from the system memory to a video buffer of the video random-access memory.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic functional block diagram illustrating a video streaming data processing system of a computer;

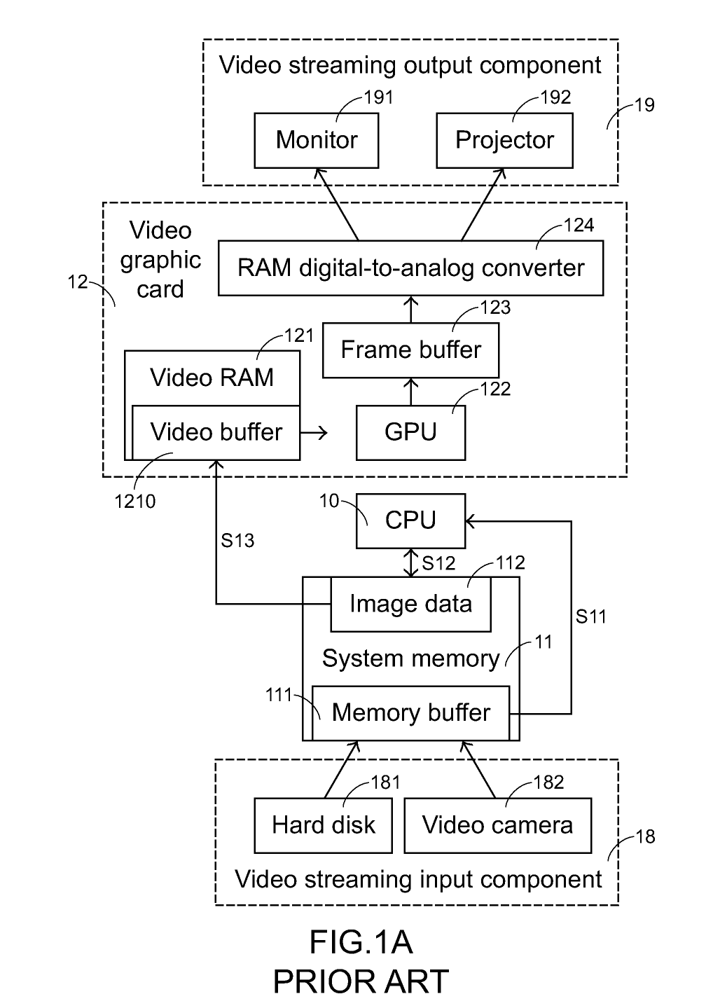

FIG. 1B schematically illustrates a flowchart of a conventional video streaming data processing method;

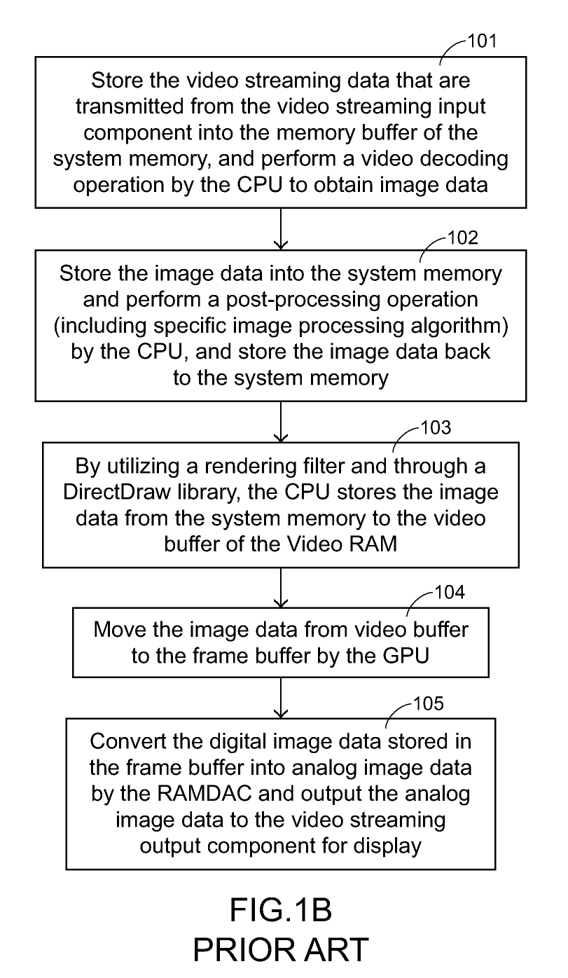

FIG. 1C is a schematic functional block diagram illustrating the procedure of storing the image data from the system memory to the video graphic card along the transmission path S13 shown in FIG. 1C;

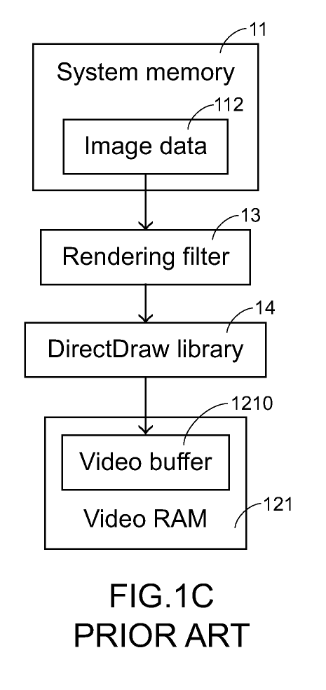

FIG. 2A is a schematic functional block diagram illustrating a video streaming data processing system according to the present invention;

FIG. 2B schematically illustrates a flowchart of a video streaming data processing method according to a first preferred embodiment of the present invention;

FIG. 2C schematically illustrates a flowchart of a video streaming data processing method according to a second preferred embodiment of the present invention;

FIG. 3A is a schematic functional block diagram illustrating the use of an allocator for transmitting the image data in the steps 203 and 303 of the flowcharts of FIGS. 2A and 2B; and

FIG. 3B is a schematic functional block diagram illustrating the use of a rendering filter for transmitting the image data in the steps 203 and 303 of the flowcharts of FIGS. 2A and 2B.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

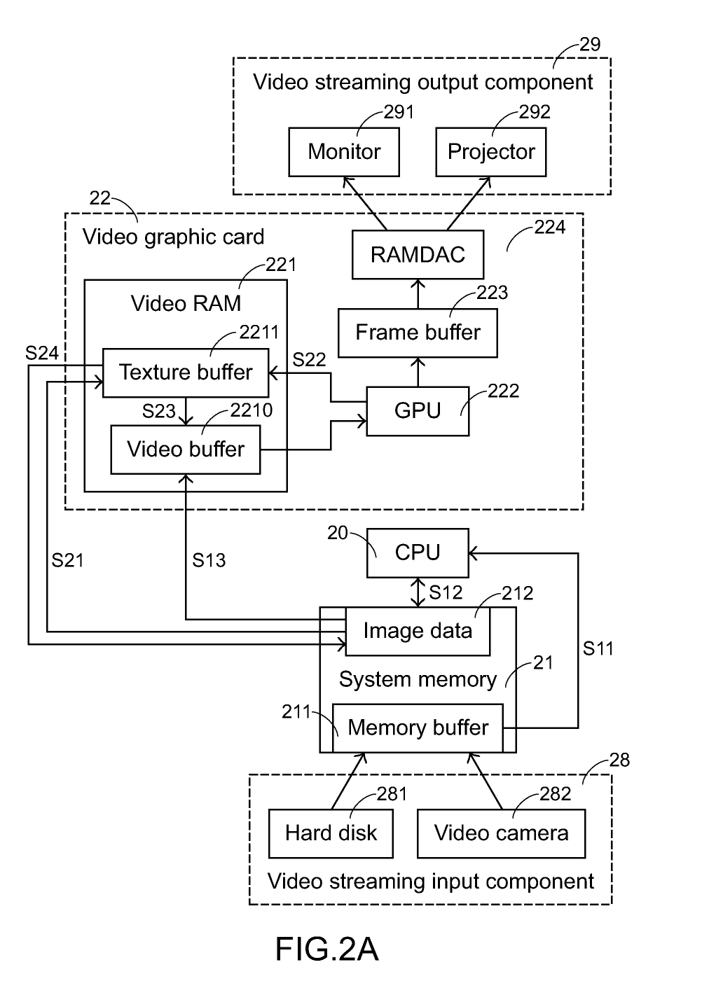

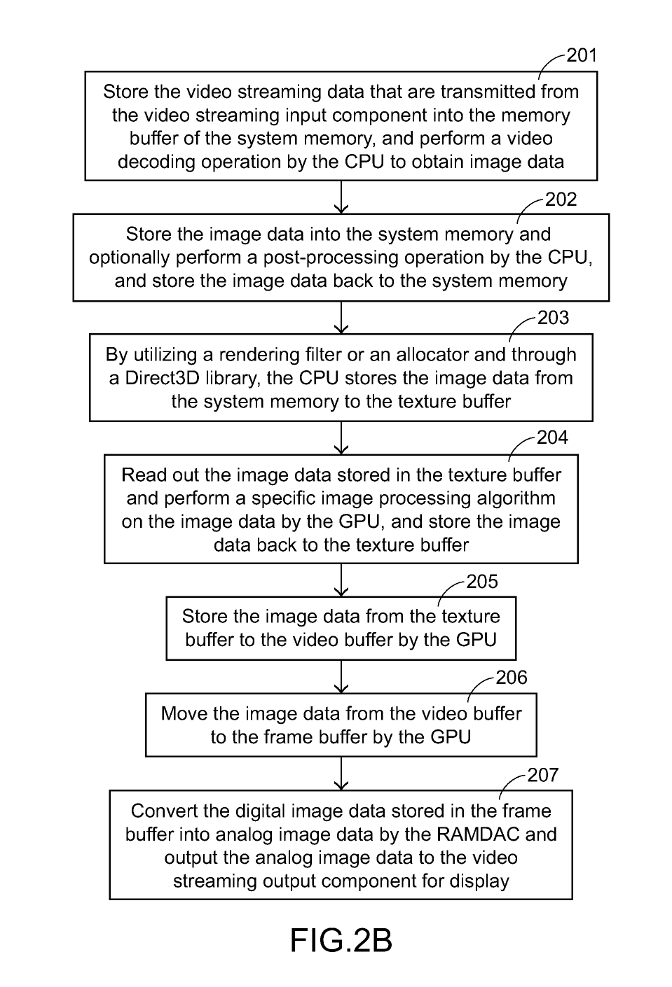

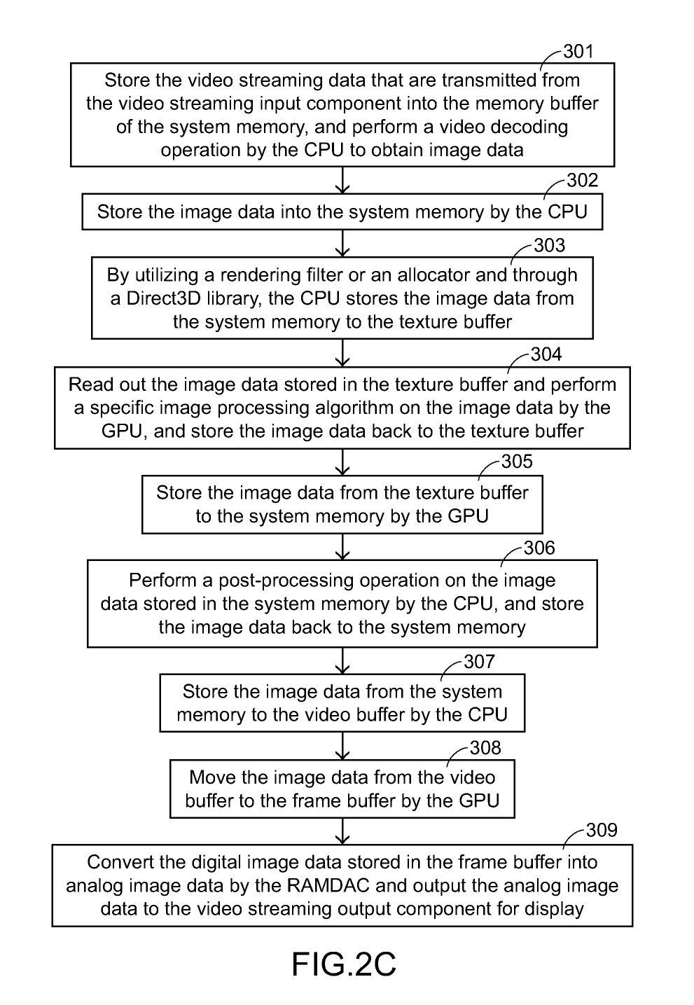

FIG. 2A is a schematic functional block diagram illustrating a video streaming data processing system according to the present invention. The video streaming data processing system of FIG. 2A can be applied to for example a computer system or a digital TV. As shown in FIG. 2A, the video streaming data processing system principally comprises three main parts, including a central processing unit (CPU) 20, a system memory 21 and a video graphic card 22. The video streaming data processing system is interconnected between a video streaming input component 28 and a video streaming output component 29. After the video streaming data generated by the video streaming input component 28 are received and processed by the video streaming data processing system, the processed video streaming data are transmitted to the video streaming output component 29 for display. An example of the video streaming input component 28 includes a hard disk 281 or a video camera 282. The hard disk 281 is used for storing the video streaming data. The video camera 282 may generate the video streaming data in real time. Alternatively, the video streaming input component 28 is a TV tuner card or a TV box. The video streaming output component 29 includes for example a monitor 291 or a projector 292.

Please refer to FIG. 2A again. The system memory 21 comprises a memory buffer 211 and image data 212. The video graphic card 22 comprises a video random-access memory (video RAM) 221 including a video buffer 2210 and a texture buffer 2211, a graphic processing unit (GPU) 222, a frame buffer 223 and a random-access memory digital-to-analog converter (RAMDAC) 224.

Hereinafter, a video streaming data processing method according to a first preferred embodiment of the present invention will be illustrated with reference to the flowchart of FIG. 2B and the video streaming data processing system of FIG. 2A.

First of all, along the transmission path S11, the video streaming data that are transmitted from the video streaming input component 28 are stored in the memory buffer 211 of the system memory 21 and then the central processing unit 20 performs a video decoding operation on the video streaming data (Step 201). Next, along the transmission path S12, the image data 212 obtained by the video decoding operation are stored from the central processing unit 20 to the system memory 21, read out and optionally subject to a post-processing operation by the central processing unit 20, and then the image data are stored back to the system memory 21 (Step 202). In this embodiment, the post-processing operation is performed according to the practical requirements. For alleviating the computing load of the central processing unit 20, the specific image processing algorithms used in the conventional video streaming data processing method (e.g. color enhancement, saturation enhancement, and the like) are excluded from the post-processing operation as described in the step 202. Next, by utilizing a software-form rendering filter (or an allocator) and through a Direct3D library, the central processing unit 20 stores the image data 212 from the system memory 21 to the texture buffer 2211 of the video RAM 221 along the transmission path S21 (Step 203). Next, the image data stored in the texture buffer 2211 are read out by the graphic processing unit (GPU) 222 of the video graphic card 22 and subject to a specific image processing algorithm (e.g. color enhancement, saturation enhancement, contrast enhancement, noise cancellation or color balance), and then the image data are stored back to the texture buffer 2211 along the transmission path S22 (Step 204). Next, along the transmission path S23, the image data after being subject to the specific image processing algorithm are stored from the texture buffer 2211 to the video buffer 2210 of the video RAM 221 by the graphic processing unit (GPU) 222 (Step 205). Next, the image data that are stored in the video buffer 2210 are moved to the frame buffer 223 of the video graphic card 22 by the graphic processing unit (GPU) 222 and ready to be transmitted to the video streaming output component 29 (Step 206). Afterwards, the digital image data stored in the frame buffer 223 are converted into analog image data by the RAMDAC 224 so as to be transmitted to the video streaming output component 29 for display (Step 207).

Hereinafter, a video streaming data processing method according to a second preferred embodiment of the present invention will be illustrated with reference to the flowchart of FIG. 2C and the video streaming data processing system of FIG. 2A.

First of all, along the transmission path S21, the video streaming data that are transmitted from the video streaming input component 28 are stored in the memory buffer 211 of the system memory 21 and then the central processing unit 20 performs a video decoding operation on the video streaming data (Step 301). Next, along the transmission path S12, the image data 212 obtained by the video decoding operation are stored from the central processing unit 20 to the system memory 21 (Step 302). Next, by utilizing a software-form rendering filter (or an allocator) and through a Direct3D library, the central processing unit 20 stores the image data 212 from the system memory 21 to the texture buffer 2211 of the video RAM 221 along the transmission path S21 (Step 303). Next, the image data stored in the texture buffer 2211 are read out by the graphic processing unit (GPU) 222 of the video graphic card 22 and subject to specific image processing algorithm (e.g. color enhancement, saturation enhancement, contrast enhancement, noise cancellation or color balance), and then the image data are stored into the texture buffer 2211 along the transmission path S22 (Step 204). Next, the image data after being subject to the specific image processing algorithm are stored from the texture buffer 2211 to the system memory 21 along the transmission path S24 (Step 305). Next, the image data stored in the system memory 21 are read out and optionally subject to a post-processing operation by the central processing unit 20, and the image data are stored back to the system memory 21 along the transmission path S12 (Step 306). In this embodiment, the post-processing operation is performed according to the practical requirements. Next, by the central processing unit 20, the image data 212 are stored from the system memory 21 to the video buffer 2210 of the video RAM 221 of the video graphic card 22 along the transmission path S13 (Step 307). Next, the image data that are stored in the video buffer 2210 are moved to the frame buffer 223 of the video graphic card 22 by the graphic processing unit (GPU) 222 and ready to be transmitted to the video streaming output component 29 (Step 308). Afterwards, the digital image data stored in the frame buffer 223 are converted into analog image data by the RAMDAC 224 so as to be transmitted to the video streaming output component 29 for display (Step 309).

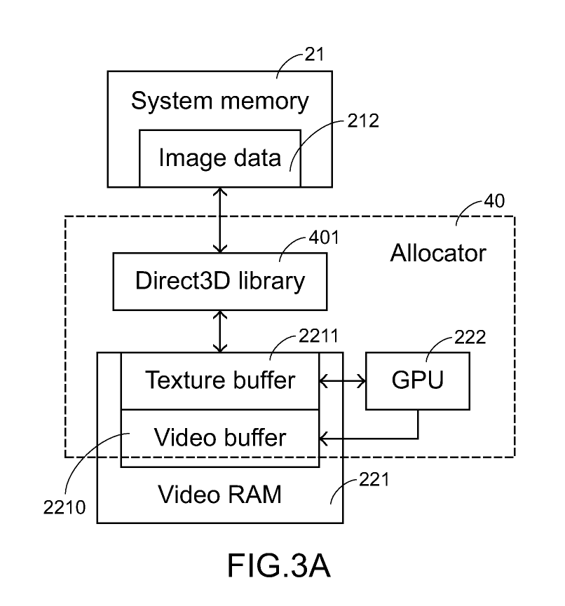

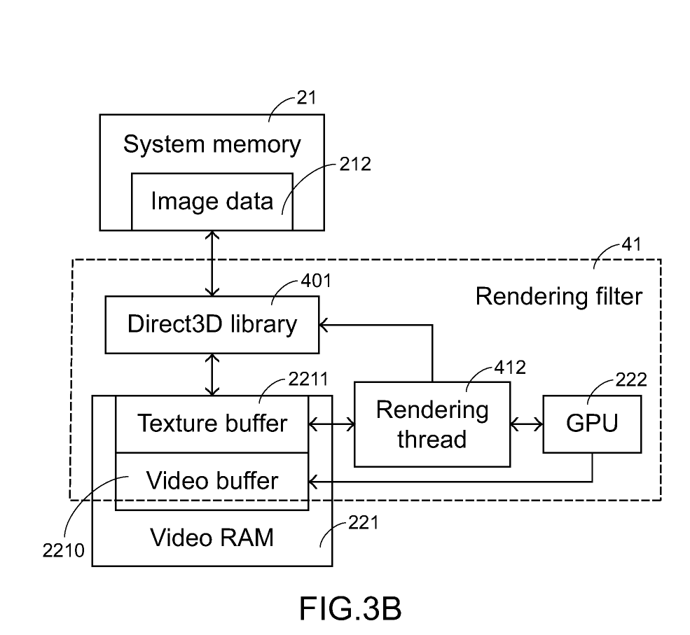

FIG. 3A is a schematic functional block diagram illustrating the use of an allocator for transmitting the image data in the steps 203 and 303 of the flowcharts of FIGS. 2A and 2B. As shown in FIG. 3A, by utilizing an allocator 40 and through a Direct3D library 401, the central processing unit 20 stores the image data 212 from the system memory 21 to the texture buffer 2211 of the video RAM 221. That is, the Direct3D library 401, the texture buffer 2211 and the video buffer 2210 cooperate with each other to store the image data 212 from the system memory 21 to the texture buffer 2211 of the video RAM 221.

FIG. 3B is a schematic functional block diagram illustrating the use of a rendering filter for transmitting the image data in the steps 203 and 303 of the flowcharts of FIGS. 2A and 2B. As shown in FIG. 3B, the rendering filter 41 also includes a Direct3D library 411 and a rendering thread 412. By utilizing the rendering filter 41 and through the Direct3D library 411, the central processing unit 20 stores the image data 212 from the system memory 21 to the texture buffer 2211 of the video RAM 221. That is, the Direct3D library 411, the rendering thread 412, the texture buffer 2211 and the video buffer 2210 cooperate with each other to store the image data 212 from the system memory 21 to the texture buffer 2211 of the video RAM 221.

The rendering thread 412 is used to process the user input events. Through the rendering thread 412, the user input events and the output image data are combined together according to the practical requirements, thereby achieving an interactive purpose.

From the above description, since the specific image processing algorithm is performed by the graphic processing unit in replace of the central processing unit, the computing load of the central processing unit is largely reduced according to the video streaming data processing method of the present invention. Under this circumstance, the video decoding operation and the specific image processing algorithm are no longer simultaneously executed. As such, the overall performance of the computer system is enhanced and the video streaming data can be normally played.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video streaming data processing method for use in a video streaming data processing system including a central processing unit, a system memory, a graphic processing unit and a video random-access memory, the video streaming data processing method comprising steps of:
receiving video streaming data;
performing a video decoding operation on the video streaming data by the central processing unit to produce image data, and then storing the image data into the system memory;
storing the image data from the system memory to a texture buffer of the video random-access memory;
reading out the image data that are stored in the texture buffer and performing a specific image processing algorithm on the image data by the graphic processing unit, and storing the image data back to the texture buffer; and
storing the image data from the texture buffer to a video buffer of the video random-access memory.

2. The video streaming data processing method according to claim 1 wherein the video streaming data are previously stored in a hard disk, or real-time generated by a video camera, a TV tuner card or a TV box.

3. The video streaming data processing method according to claim 1 wherein before the step of storing the image data from the system memory to a texture buffer of the video random-access memory, the video streaming data processing method further comprises a step of performing a post-processing operation on the image data by the central processing unit and storing the image data back to the system memory.

4. The video streaming data processing method according to claim 1 wherein the specific image processing algorithm includes color enhancement, saturation enhancement, contrast enhancement, noise cancellation or color balance.

5. The video streaming data processing method according to claim 1 wherein after the step of storing the image data from the texture buffer to the video buffer of the video random-access memory, the video streaming data processing method further comprises steps of:
moving the image data that are stored in the video buffer to a frame buffer by the graphic processing unit;
converting the image data that are in the frame buffer and in a digital form into analog image data by a random-access memory digital-to-analog converter; and
transmitting the analog image data to a video streaming output component for display.

6. The video streaming data processing method according to claim 5 wherein the video streaming output component is a monitor or a projector.

7. The video streaming data processing method according to claim 1 wherein the central processing unit stores the image data from the system memory to the texture buffer by utilizing an allocator and through a Direct3D library.

8. The video streaming data processing method according to claim 1 wherein the central processing unit stores the image data from the system memory to the texture buffer by utilizing a rendering filter and through a Direct3D library.

9. The video streaming data processing method according to claim 8 wherein the rendering filter includes a rendering thread for combining the video streaming data with user input events, thereby achieving an interactive purpose.

10. A video streaming data processing method for use in a video streaming data processing system including a central processing unit, a system memory, a graphic processing unit and a video random-access memory, the video streaming data processing method comprising steps of:
receiving video streaming data;
performing a video decoding operation on the video streaming data by the central processing unit to produce image data, and then storing the image data into the system memory;
storing the image data from the system memory to a texture buffer of the video random-access memory;
reading out the image data that are stored in the texture buffer and performing a specific image processing algorithm on the image data by the graphic processing unit, and storing the image data back to the texture buffer;
storing the image data from the texture buffer to the system memory;
reading out the image data stored in the system memory and performing a post-processing operation on the image data by the central processing unit, and storing the image data back to the system memory; and
storing the image data from the system memory to a video buffer of the video random-access memory.

11. The video streaming data processing method according to claim 10 wherein the video streaming data are previously stored in a hard disk, or real-time generated by a video camera, a TV tuner card or a TV box.

12. The video streaming data processing method according to claim 10 wherein the specific image processing algorithm includes color enhancement, saturation enhancement, contrast enhancement, noise cancellation or color balance.

13. The video streaming data processing method according to claim 10 wherein after the step of storing the image data from the system memory to the video buffer of the video random-access memory, the video streaming data processing method further comprises steps of:
moving the image data that are stored in the video buffer to a frame buffer by the graphic processing unit;
converting the image data that are stored in the frame buffer and in a digital form into analog image data by a random-access memory digital-to-analog converter; and
transmitting the analog image data to a video streaming output component for display.

14. The video streaming data processing method according to claim 13 wherein the video streaming output component is a monitor or a projector.

15. The video streaming data processing method according to claim 10 wherein the central processing unit stores the image data from the system memory to the texture buffer by utilizing an allocator and through a Direct3D library.

16. The video streaming data processing method according to claim 10 wherein the central processing unit stores the image data from the system memory to the texture buffer by utilizing a rendering filter and through a Direct3D library.

17. The video streaming data processing method according to claim 10 wherein the rendering filter includes a rendering thread for combining the video streaming data with user input events, thereby achieving an interactive purpose.
